(19) United States
(12) Patent Application Publication
(10) Pub. No.: US 2026/0178317 A1
(43) Pub. Date: Jun. 25, 2026

(54) DISTRIBUTED WEB APPLICATION

(71) Applicant: American Megatrends International, LLC, Duluth, GA (US)

(72) Inventors: Asif Kareem A, Kannur (IN); Chitrak Gupta, Johns Creek, GA (US); Dharani Bharathi T, Chennai (IN); Sriram Santhanam, Chennai (IN); Vigneshwar Kumaran V, Channai (IN)

(21) Appl. No.: 18/987,725

(22) Filed: Dec. 19, 2024

(51) Int. Cl. G06F 8/656; G06F 40/186; H04L 67/10

(52) U.S. Cl. CPC G06F 8/656; G06F 40/186; H04L 67/10

(57) ABSTRACT

In an aspect of the disclosure, a method, a computer-readable medium, and a system are provided. The system may include one or more computing devices. The one or more computing devices serve a controller page and a service page to a client machine. The one or more computing devices receive, through the controller page, a service file package containing software components and a template file for a new service. The one or more computing devices deploy the software components for the new service to one or more servers based on the template file. The one or more computing devices update a database with information about the deployed new service. The one or more computing devices modify the service page to include the deployed new service.

### BACKGROUND

### Field

The present disclosure relates generally to computing systems, and more particularly, to techniques of dynamically integrating and deploying web-based services into a cloud platform system during runtime.

### Background

The statements in this section merely provide background information related to the present disclosure and may not constitute prior art.

Considerable developments have been made in the arena of server management. An industry standard called Intelligent Platform Management Interface (IPMI), described in, e.g., “IPMI: Intelligent Platform Management Interface Specification, Second Generation,” v.2.0, Feb. 12, 2004, defines a protocol, requirements and guidelines for implementing a management solution for server-class computer systems. The features provided by the IPMI standard include power management, system event logging, environmental health monitoring using various sensors, watchdog timers, field replaceable unit information, in-band and out of band access to the management controller, SNMP traps, etc.

A component that is normally included in a server-class computer to implement the IPMI standard is known as a Baseboard Management Controller (BMC). A BMC is a specialized microcontroller embedded on the motherboard of the computer, which manages the interface between the system management software and the platform hardware. The BMC generally provides the “intelligence” in the IPMI architecture.

The BMC may be considered as an embedded-system device or a service processor. A BMC may require a firmware image to make them operational. “Firmware” is software that is stored in a read-only memory (ROM) (which may be reprogrammable), such as a ROM, programmable read-only memory (PROM), erasable programmable read-only memory (EPROM), electrically erasable programmable read-only memory (EEPROM), etc.

In modern cloud computing environments and data centers, applications are increasingly being built using microservices architecture, where applications are decomposed into smaller, independently deployable services. These microservices can be deployed either on-premises or in cloud environments, with each service providing specific functionality through web interfaces. The microservices typically communicate with each other through APIs and network protocols, allowing for a distributed and scalable system architecture.

Traditional web application deployment in cloud platforms followed a monolithic approach where all services and their corresponding web interfaces were tightly coupled and deployed together. When organizations needed to add new services or modify existing ones, they had to undergo a complete rebuild and redeployment process of the entire web application. This approach required significant manual intervention and often resulted in system downtime during the deployment process. The manual process typically involved several steps: manually deploying the new service, creating appropriate links or endpoints, and manually modifying the main webpage to incorporate the new service.

The limitations of this traditional approach became more apparent as organizations moved towards more dynamic and rapidly evolving cloud environments. The need to rebuild and redeploy the entire application for each new service addition created bottlenecks in the development and deployment pipeline. Furthermore, the manual nature of the integration process increased the risk of human error and required specialized knowledge of the system architecture. Organizations often had to rely on third-party plugins or services to facilitate the integration process, which reduced their control over the deployment process and created additional dependencies.

These challenges were particularly problematic in enterprise environments where multiple teams developed different services that needed to be integrated into a single cohesive platform. The manual deployment process not only consumed significant time and resources but also created coordination challenges between teams. The requirement for system rebuilds and the resulting downtime affected the overall availability of the platform's services.

The existing solutions also lacked the ability to dynamically integrate new services during runtime. Any modifications to the web application required stopping the current services, rebuilding the application with the new changes, and restarting the system. This limitation made it difficult for organizations to rapidly respond to changing business needs or quickly deploy new services without impacting existing operations. The lack of runtime integration capabilities also meant that organizations had to carefully plan and coordinate service deployments, often scheduling them during off-peak hours to minimize disruption to users.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and a system are provided. The system may include one or more computing devices. The one or more computing devices serve a controller page and a service page to a client machine. The one or more computing devices receive, through the controller page, a service file package containing software components and a template file for a new service. The one or more computing devices deploy the software components for the new service to one or more servers based on the template file. The one or more computing devices update a database with information about the deployed new service. The one or more computing devices modify the service page to include the deployed new service.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating a computer system including a baseboard management controller and a host computer.

FIG. 2 is a diagram illustrating a distributed web application system that enables runtime integration of new services through a controller service.

FIG. 3 is a flow chart of a process for dynamically integrating new services into a cloud platform system during runtime.

FIG. 4 is a flow chart of a process for modifying a service page in the cloud platform system.

FIG. 5 is a flow chart a method for integrating new services into a cloud platform system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of computer systems will now be presented with reference to various apparatus and methods. These apparatus and methods will be described in the following detailed description and illustrated in the accompanying drawings by various blocks, components, circuits, processes, algorithms, etc. (collectively referred to as elements). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a processing system that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

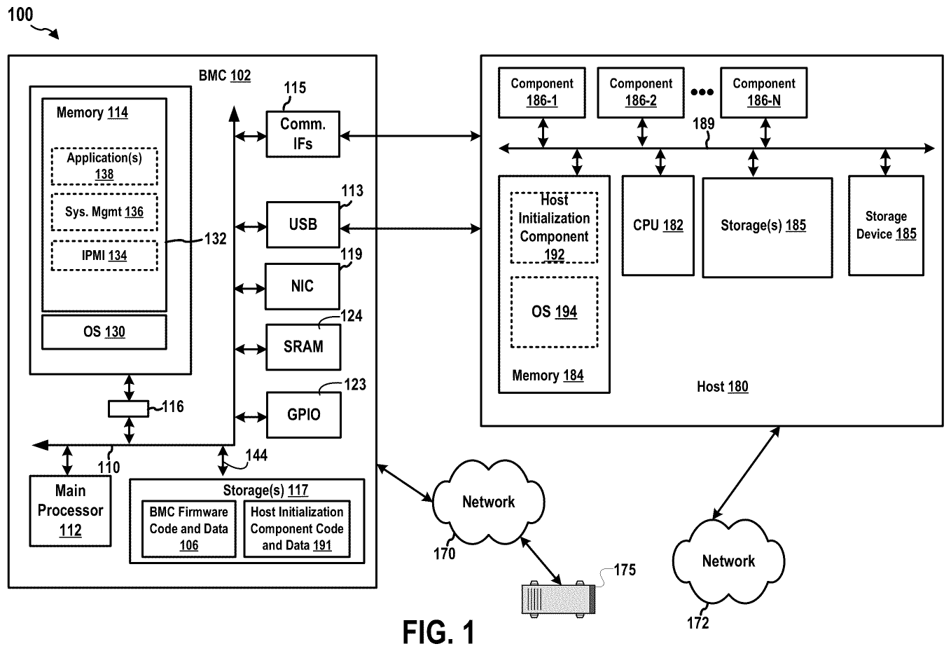

FIG. 1 is a diagram illustrating a computer system 100. In this example, the computer system includes, among other devices, a baseboard management controller (BMC) 102 and a host computer 180. The BMC 102 has, among other components, a main processor 112, a memory 114 (e.g., a dynamic random access memory (DRAM)), a memory driver 116, storage(s) 117, a network interface card 119, a USB interface 113 (i.e., Universal Serial Bus), other communication interfaces 115, a SRAM 124 (i.e., static RAM), and a GPIO interface 123 (i.e., general purpose input/output interface).

The communication interfaces 115 may include a keyboard controller style (KCS), a server management interface chip (SMIC), a block transfer (BT) interface, a system management bus system interface (SSIF), and/or other suitable communication interface(s). Further, as described infra, the BMC 102 supports IPMI and provides an IPMI interface between the BMC 102 and the host computer 180. The IPMI interface may be implemented over one or more of the USB interface 113, the network interface card 119, and the communication interfaces 115.

In certain configurations, one or more of the above components may be implemented as a system-on-a-chip (SoC). For examples, the main processor 112, the memory 114, the memory driver 116, the storage(s) 117, the network interface card 119, the USB interface 113, and/or the communication interfaces 115 may be on the same chip. In addition, the memory 114, the main processor 112, the memory driver 116, the storage(s) 117, the communication interfaces 115, and/or the network interface card 119 may be in communication with each other through a communication channel 110 such as a bus architecture.

The BMC 102 may store BMC firmware code and data 106 in the storage(s) 117. The storage(s) 117 may utilize one or more non-volatile, non-transitory storage media. During a boot-up, the main processor 112 loads the BMC firmware code and data 106 into the memory 114. In particular, the BMC firmware code and data 106 can provide in the memory 114 an BMC OS 130 (i.e., operating system) and service components 132. The service components 132 include, among other components, IPMI services 134, a system management component 136, and application(s) 138. Further, the service components 132 may be implemented as a service stack. As such, the BMC firmware code and data 106 can provide an embedded system to the BMC 102.

The BMC 102 may be in communication with the host computer 180 through the USB interface 113, the network interface card 119, the communication interfaces 115, and/or the IPMI interface, etc.

The host computer 180 includes a host CPU 182, a host memory 184, storage device(s) 185, and component devices 186-1 to 186-N. The component devices 186-1 to 186-N can be any suitable type of hardware components that are installed on the host computer 180, including additional CPUs, memories, and storage devices. As a further example, the component devices 186-1 to 186-N can also include Peripheral Component Interconnect Express (PCIe) devices, a redundant array of independent disks (RAID) controller, and/or a network controller.

Further, the storage(s) 117 may store host initialization component code and data 191 for the host computer 180. After the host computer 180 is powered on, the host CPU 182 loads the initialization component code and data 191 from the storage(s) 117 though the communication interfaces 115 and the communication channel 110. The host initialization component code and data 191 contains an initialization component 192. The host CPU 182 executes the initialization component 192. In one example, the initialization component 192 is a basic input/output system (BIOS). In another example, the initialization component 192 implements a Unified Extensible Firmware Interface (UEFI). UEFI is defined in, for example, “Unified Extensible Firmware Interface Specification Version 2.6, dated January 2016,” which is expressly incorporated by reference herein in their entirety. As such, the initialization component 192 may include one or more UEFI boot services.

The initialization component 192, among other things, performs hardware initialization during the booting process (power-on startup). For example, when the initialization component 192 is a BIOS, the initialization component 192 can perform a Power On System Test, or Power On Self Test, (POST). The POST is used to initialize the standard system components, such as system timers, system DMA (Direct Memory Access) controllers, system memory controllers, system I/O devices and video hardware (which are part of the component devices 186-1 to 186-N). As part of its initialization routine, the POST sets the default values for a table of interrupt vectors. These default values point to standard interrupt handlers in the memory 114 or a ROM. The POST also performs a reliability test to check that the system hardware, such as the memory and system timers, is functioning correctly. After system initialization and diagnostics, the POST surveys the system for firmware located on non-volatile memory on optional hardware cards (adapters) in the system. This is performed by scanning a specific address space for memory having a given signature. If the signature is found, the initialization component 192 then initializes the device on which it is located. When the initialization component 192 includes UEFI boot services, the initialization component 192 may also perform procedures similar to POST.

After the hardware initialization is performed, the initialization component 192 can read a bootstrap loader from a predetermined location from a boot device of the storage device(s) 185, usually a hard disk of the storage device(s) 185, into the host memory 184, and passes control to the bootstrap loader. The bootstrap loader then loads an OS 194 into the host memory 184. If the OS 194 is properly loaded into memory, the bootstrap loader passes control to it. Subsequently, the OS 194 initializes and operates. Further, on certain disk-less, or media-less, workstations, the adapter firmware located on a network interface card re-routes the pointers used to bootstrap the operating system to download the operating system from an attached network.

The service components 132 of the BMC 102 may manage the host computer 180 and is responsible for managing and monitoring the server vitals such as temperature and voltage levels. The service stack can also facilitate administrators to remotely access and manage the host computer 180. In particular, the BMC 102, via the IPMI services 134, may manage the host computer 180 in accordance with IPMI. The service components 132 may receive and send IPMI messages to the host computer 180 through the IPMI interface.

Further, the host computer 180 may be connected to a data network 172. In one example, the host computer 180 may be a computer system in a data center. Through the data network 172, the host computer 180 may exchange data with other computer systems in the data center or exchange data with machines on the Internet.

The BMC 102 may be in communication with a communication network 170 (e.g., a local area network (LAN)). In this example, the BMC 102 may be in communication with the communication network 170 through the network interface card 119. Further, the communication network 170 may be isolated from the data network 172 and may be out-of-band to the data network 172 and out-of-band to the host computer 180. In particular, communications of the BMC 102 through the communication network 170 do not pass through the OS 194 of the host computer 180. In certain configurations, the communication network 170 may not be connected to the Internet. In certain configurations, the communication network 170 may be in communication with the data network 172 and/or the Internet. In addition, through the communication network 170, a remote device 175 may communicate with the BMC 102. For example, the remote device 175 may send IPMI messages to the BMC 102 over the communication network 170.

Further, the storage(s) 117 is in communication with the communication channel 110 through a communication link 144.

In modern computing environments, particularly in cloud platforms and data centers as described in the computer system 100, there is a growing trend towards microservices architecture where applications are decomposed into smaller, independently deployable services. These microservices can be deployed either on-premises or in cloud environments, communicating through the data network 172 or communication network 170.

A significant challenge arises when attempting to integrate new web-based services into an existing cloud platform system. In a first technical scheme, when a user wants to add a new service they have created, they must undergo a manual, time-consuming process that involves several steps. First, they must manually deploy their new service to the host computer 180 or other computing resources. Then, they need to create a link for the new service, and finally, they must manually modify the main webpage to incorporate the new service. This process requires significant manual intervention and often necessitates redeployment of the main webpage, resulting in system downtime.

The manual integration process is particularly problematic because it requires rebuilding and redeploying the entire web application during build time. This approach is inefficient and creates dependencies on third-party plugins or services, reducing control over the integration process. Furthermore, when the host computer 180 needs to restart to accommodate these changes, it disrupts the services provided through the data network 172 to other systems in the data center.

This architecture creates a bottleneck in service integration. When new services need to be added to the cloud platform, the lack of runtime integration capabilities forces system administrators to rely on build-time modifications. This limitation affects the system's scalability and agility.

The problem is exacerbated in environments where multiple teams create different web-based services that need to be integrated into the main cloud platform interface. The manual deployment process not only consumes significant time and resources but also introduces the risk of human error during the integration process. Additionally, the requirement to redeploy the main webpage for each new service integration creates unnecessary system downtime, affecting the overall availability of the cloud platform services running on the host computer 180.

These challenges highlight the need for a more efficient, automated approach to service integration that can operate during runtime without requiring system rebuilds or creating dependencies on third-party solutions. Such an approach would need to leverage the existing infrastructure of the computer system 100 while providing a more streamlined method for service deployment and webpage integration.

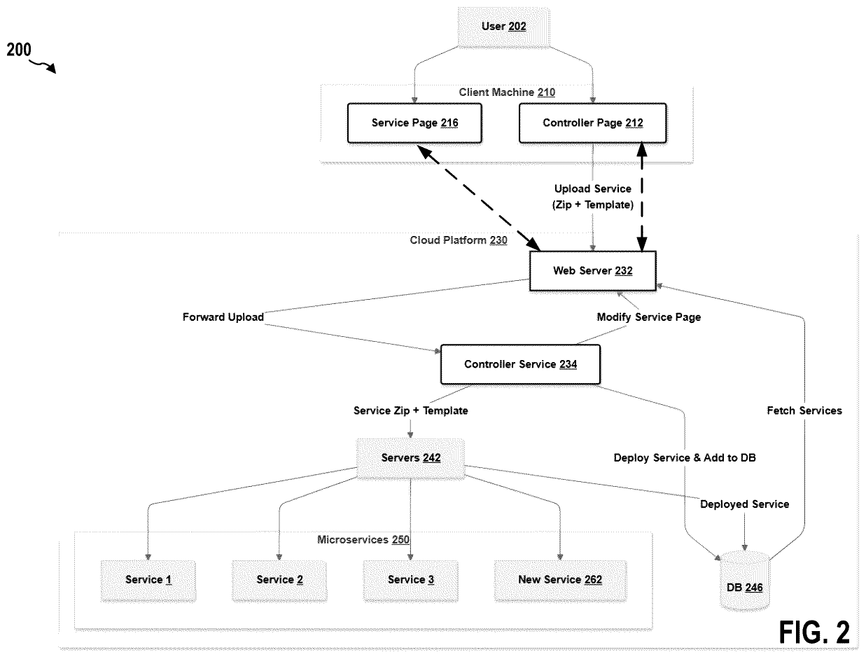

FIG. 2 illustrates a distributed web application system 200 that addresses the challenges of integrating new services during runtime according to a second technical scheme. The system 200 includes a client machine 210, which hosts a service page 216 and a controller page 212. A user 202 interacts with both the service page 216 and the controller page 212 through a web interface.

The system 200 incorporates a cloud platform 230 that contains multiple components working in concert. At the front end, a web server 232 serves both the service page 216 and the controller page 212 to the client machine 210. The web server 232 acts as the primary interface between the user 202 and the cloud platform's backend services.

Within the cloud platform 230, a controller service 234 functions as a dedicated microservice that manages the deployment and integration of new services. When the user 202 uploads a service through the controller page 212, the package containing both the service zip file and its associated template is first received by the web server 232, which then forwards it to the controller service 234.

The cloud platform 230 includes servers 242 that host various microservices 250, including service 1, service 2, service 3, and can accommodate a new service 262. The controller service 234 deploys the uploaded service package to these servers 242, which then execute the service as part of the microservices architecture.

A cloud platform DB 246 maintains records of all deployed services and their configurations. The controller service 234 updates this database when new services are deployed, and the web server 232 queries it to display the current set of available services on the service page 216.

This architecture provides a solution to the manual deployment problem described in the first technical scheme. Instead of requiring manual intervention and system rebuilds, the system 200 enables runtime integration of new services. When a user uploads a new service through the controller page 212, the controller service 234 automatically handles the deployment process, updates the cloud platform DB 246, and signals the web server 232 to modify the service page 216 accordingly.

The system 200 operates without disrupting existing services or requiring system downtime. This is achieved through the controller service 234's ability to deploy new services independently and update the web interface dynamically. The architecture eliminates the need for manual webpage modifications and rebuilds that were previously required when integrating new services into the cloud platform system.

When the user 202 uploads a new service, the data flows from the controller page 212 through the web server 232 to the controller service 234. The controller service 234 then manages the deployment to the servers 242, updates the cloud platform DB 246, and coordinates with the web server 232 to reflect these changes in the service page 216.

This architecture is particularly beneficial in the context of the computer system 100 described earlier, as it can operate effectively within both the data network 172 and communication network 170 environments. The system 200 can be implemented on the host computer 180, utilizing its resources while maintaining the security and management capabilities provided by the BMC 102.

More specifically, in this example, in the cloud platform system 200, the service page 216 initially displays multiple services (e.g., service 1, service 2, and service 3) that are deployed and accessible to the user 202. The controller page 212, served by the web server 232, provides an interface through which the user 202 can upload new services to the cloud platform 230.

The system allows uploading a service as a zip file through the controller page 212. When the user 202 uploads a new service package, which includes both the service zip file and an associated template containing service-related data, the web server 232 receives this package and forwards it to the controller service 234. The template contains essential information such as deployment instructions, required icons, and section specifications that guide the controller service 234 in properly integrating the new service.

After the controller service 234 processes the upload, it performs several automated actions. First, it deploys the new service to the servers 242, where it joins the existing microservices 250. The controller service 234 then updates the cloud platform DB 246 with the new service information. Following successful deployment, the system notifies the user 202 about the deployment status and provides a link to access the newly deployed service.

The modification of the service page 216 may not require system downtime. The web server 232, upon receiving confirmation from the controller service 234, updates the service page 216 to include the newly deployed service. The user 202 can then refresh their browser to see the updated service page 216, which now includes the new service alongside the existing services. This dynamic update capability may eliminate the need for manual webpage modifications or system rebuilds that were previously required.

The controller service 234 acts as a middle layer that maintains control over the entire web application distribution process. It manages the integration of new webpages into the main service page 216, handles database updates, and coordinates the deployment process. This centralized control through the controller service 234 eliminates dependencies on third-party plugins and provides a streamlined, automated approach to service integration.

The system addresses the technical limitations in the first technical scheme where adding new services required manual deployment, manual link creation, and manual webpage modifications. By automating these processes through the controller service 234 and providing a structured upload mechanism through the controller page 212, the system enables runtime integration of new services without disrupting existing operations or requiring system downtime.

This second technical scheme is effective in cloud environments where multiple teams create different web-based services that need to be integrated into the main cloud platform interface. The automated deployment and integration process significantly reduces the time and effort required to add new services while maintaining system stability and availability.

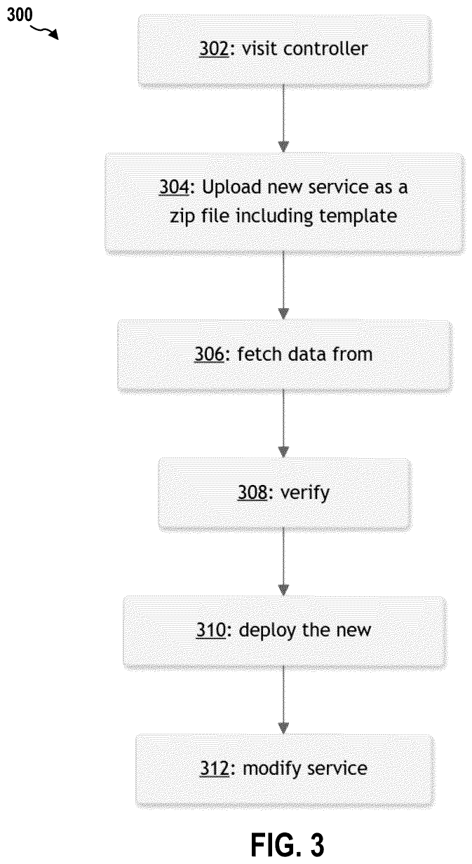

FIG. 3 illustrates a flow chart 300 of a process for dynamically integrating new services into a cloud platform system during runtime. The process begins at operation 302, where a user visits the controller page 212 through a web interface provided by the web server 232. The controller page 212 serves as an entry point for service integration, offering a user interface specifically designed for service uploads and deployment management.

In operation 304, the user uploads a service package of the new service 262 to the cloud platform 230. This package includes two key components: a zip file containing the service implementation and a template file. The template file contains essential metadata and configuration information required for proper service deployment and integration. The web server 232 receives this upload through the controller page 212 and forwards it to the controller service 234 for processing.

In operation 306, the controller service 234 fetches and parses data from the uploaded template. The template contains information such as deployment instructions, required icons, section specifications, and other configuration parameters that guide the integration process. This step is particularly important as it determines how the new service will be positioned and presented within the existing service page 216.

In operation 308, the controller service 234 performs template verification to validate the provided configuration data. This verification step helps prevent integration issues by confirming that all required information is present and correctly formatted. The controller service 234 checks various parameters including deployment host information, port specifications, and integration requirements.

In operation 310, the controller service 234 processes the zip file and deploys the service according to the specifications provided in the template. During this operation, the new service 262 joins the existing microservices 250 (service 1, service 2, and service 3) in the cloud platform 230. The controller service 234 also updates the cloud platform DB 246 with information about the newly deployed service.

Finally, in operation 312, the controller service 234 initiates the modification of the service page 216. This modification occurs dynamically at runtime, without requiring system downtime or manual intervention. The web server 232 updates the service page 216 to include a hyperlink or interface element for the newly deployed service. Users can then access the new service through the updated service page 216 after a simple page refresh.

This process addresses the technical limitations of manual deployment methods described in the first technical scheme. Instead of requiring manual deployment, manual link creation, and manual webpage modifications, the system automates these steps through the controller service 234. The process eliminates the need for system rebuilds and reduces dependencies on third-party plugins, while maintaining system stability and availability. The controller service 234 acts as a central coordinator, managing the entire process from upload to deployment and integration, while maintaining proper records in the cloud platform DB 246.

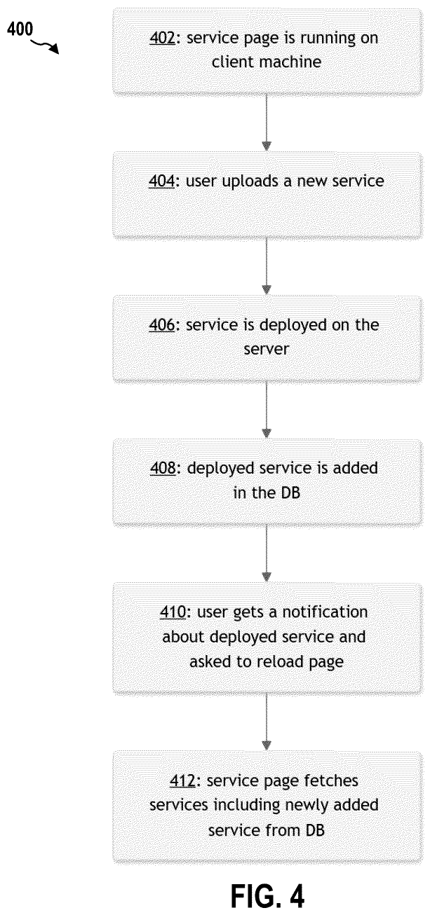

FIG. 4 is a flow chart 400 of a process for modifying a service page in the cloud platform system. In operation 402, the service page 216 is actively running on the client machine 210. This page serves as the main interface through which users access various microservices deployed in the cloud platform 230. The service page 216, served by the web server 232, initially displays the existing services (service 1, service 2, and service 3) that are already deployed and accessible to the user 202.

In operation 404, the user 202 initiates the upload of a new service through the controller page 212. This upload includes both the service implementation as a zip file and an associated template containing configuration data. The web server 232 receives this upload and forwards it to the controller service 234 for processing.

In operation 406, the controller service 234 deploys the new service 262 to the servers 242 within the cloud platform 230. The deployment process follows the specifications provided in the template, including host information and configuration parameters. This operation transforms the uploaded service package into an active microservice within the cloud platform's infrastructure.

In operation 408, after successful deployment, the controller service 234 updates the cloud platform DB 246 with information about the newly deployed service. This database update is for maintaining accurate records of all available services and their configurations. The cloud platform DB 246 serves as the central repository for service information that the web server 232 uses to generate the service page 216.

In operation 410, the user 202 about is notified about the successful deployment of the service. The system sends a notification through the web server 232 to the client machine 210, informing the user that the new service has been successfully deployed and requesting a page reload to view the updated service page 216.

Finally, in operation 412, when the user reloads the service page 216, the web server 232 fetches the updated service information from the cloud platform DB 246. This information now includes the newly added service alongside the existing services. The web server 232 generates an updated service page 216 that incorporates all services, making the new service accessible through the main interface.

This process addresses the technical challenges outlined in the first technical scheme where service integration required manual deployment and webpage modifications. The sequence may eliminate the need for system rebuilds and reduces dependencies on third-party plugins while maintaining system stability. The controller service 234 acts as a central coordinator, managing the entire process from upload to deployment and integration, while maintaining proper records in the cloud platform DB 246. This approach enables runtime integration of new services without disrupting existing operations, providing a more efficient and automated solution for service deployment and webpage modification in the cloud platform environment.

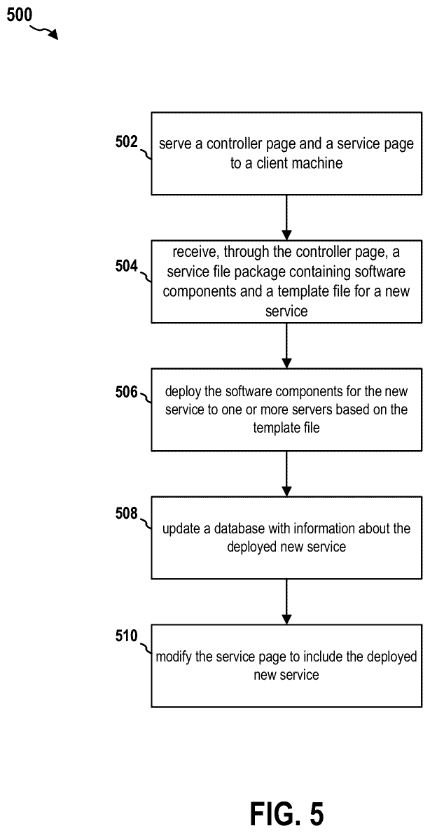

FIG. 5 is a flow chart 500 of a method for integrating new services into a cloud platform system. The method may be performed by one or more computing devices (e.g., the web server 232 and controller service 234).

In operation 502, the one or more computing devices serve a controller page and a service page to a client machine. In operation 504, the one or more computing devices receive, through the controller page, a service file package containing software components and a template file for a new service. In operation 506, the one or more computing devices deploy the software components for the new service to one or more servers based on the template file. In operation 508, the one or more computing devices update a database with information about the deployed new service. In operation 510, the one or more computing devices modify the service page to include the deployed new service.

To modify the service page, the one or more computing devices send a notification to the client machine indicating successful deployment of the new service, receive a request to reload the service page, fetch updated service information including the deployed new service from the database, and generate an updated service page incorporating the deployed new service.

In certain configurations, the service file package comprises a zip file containing the software components, and the template file contains deployment instructions and configuration parameters for the new service.

Prior to deploying the software components, the one or more computing devices verify the template file by validating deployment host information and port specifications included in the template file.

To deploy the software components, the one or more computing devices parse the template file to extract deployment instructions, deploy the new service to the one or more servers according to the deployment instructions, and integrate the new service with existing services running on the one or more servers.

To modify the service page, the one or more computing devices dynamically update the service page during runtime without requiring system downtime or manual intervention.

In certain configurations, the one or more computing devices forward the received service file package from a web server to a controller service, wherein the controller service performs the deploying, updating, and coordinates the modifying of the service page.

In certain configurations, the service page displays hyperlinks to a plurality of existing services prior to receiving the service file package, and modifying the service page includes adding a hyperlink to the deployed new service.

The one or more computing devices maintain records of all deployed services and their configurations in the database and use the records to generate the service page displaying available services.

To deploy the software components, the one or more computing devices extract deployment host information from the template file, deploy the new service to a specified host according to the deployment host information, and configure the new service based on configuration parameters included in the template file.

To update the database, the one or more computing devices store service identification information, deployment location information, and configuration parameters associated with the deployed new service.

In certain configurations, the controller page and the service page are served by a web server, and deploying the software components is performed by a controller service separate from the web server.

To modify the service page, the one or more computing devices retrieve service information from the database, generate an updated user interface incorporating the deployed new service, and serve the updated user interface to the client machine upon receiving a page reload request.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method, implemented by one or more computing devices, comprising:
serving a controller page and a service page to a client machine;
receiving, through the controller page, a service file package containing software components and a template file for a new service;
deploying the software components for the new service to one or more servers based on the template file;
updating a database with information about the deployed new service; and
modifying the service page to include the deployed new service.

2. The method of claim 1, wherein modifying the service page comprises:
sending a notification to the client machine indicating successful deployment of the new service;
receiving a request to reload the service page;
fetching updated service information including the deployed new service from the database; and
generating an updated service page incorporating the deployed new service.

3. The method of claim 1, wherein the service file package comprises a zip file containing the software components, wherein the template file contains deployment instructions and configuration parameters for the new service.

4. The method of claim 1, further comprising:
verifying the template file prior to deploying the software components, wherein the verifying comprises validating deployment host information and port specifications included in the template file.

5. The method of claim 1, wherein deploying the software components comprises:
parsing the template file to extract deployment instructions;
deploying the new service to the one or more servers according to the deployment instructions; and
integrating the new service with existing services running on the one or more servers.

6. The method of claim 1, wherein modifying the service page comprises:
dynamically updating the service page during runtime without requiring system downtime or manual intervention.

7. The method of claim 1, further comprising:
forwarding the received service file package from a web server to a controller service;
wherein the controller service performs the deploying, updating, and coordinates the modifying of the service page.

8. The method of claim 1, wherein the service page displays hyperlinks to a plurality of existing services prior to receiving the service file package, and wherein modifying the service page comprises adding a hyperlink to the deployed new service.

9. The method of claim 1, further comprising:
maintaining records of all deployed services and their configurations in the database; and
using the records to generate the service page displaying available services.

10. The method of claim 1, wherein deploying the software components comprises:
extracting deployment host information from the template file;
deploying the new service to a specified host according to the deployment host information; and
configuring the new service based on configuration parameters included in the template file.

11. The method of claim 1, wherein updating the database comprises:
storing service identification information;
storing deployment location information; and
storing configuration parameters associated with the deployed new service.

12. The method of claim 1, wherein the controller page and the service page are served by a web server, and wherein deploying the software components is performed by a controller service separate from the web server.

13. The method of claim 1, wherein modifying the service page comprises:
retrieving service information from the database;
generating an updated user interface incorporating the deployed new service; and
serving the updated user interface to the client machine upon receiving a page reload request.

14. A system, including one or more computing devices, comprising:
a memory; and
at least one processor coupled to the memory and configured to:
serve a controller page and a service page to a client machine;
receive, through the controller page, a service file package containing software components and a template file for a new service;
deploy the software components for the new service to one or more servers based on the template file;
update a database with information about the deployed new service; and
modify the service page to include the deployed new service.

15. The system of claim 14, wherein to modify the service page, the at least one processor is configured to:
send a notification to the client machine indicating successful deployment of the new service;
receive a request to reload the service page;
fetch updated service information including the deployed new service from the database; and
generate an updated service page incorporating the deployed new service.

16. The system of claim 14, wherein the service file package comprises a zip file containing the software components, wherein the template file contains deployment instructions and configuration parameters for the new service.

17. The system of claim 14, wherein the at least one processor is further configured to:
verify the template file prior to deploying the software components, wherein the verifying comprises validating deployment host information and port specifications included in the template file.

18. The system of claim 14, wherein to deploy the software components, the at least one processor is configured to:
parse the template file to extract deployment instructions;
deploy the new service to the one or more servers according to the deployment instructions; and
integrate the new service with existing services running on the one or more servers.

19. The system of claim 14, wherein to modify the service page, the at least one processor is configured to:
dynamically update the service page during runtime without requiring system downtime or manual intervention.

20. A non-transitory computer-readable medium storing computer executable code for operating one or more computing devices, comprising code to:
serve a controller page and a service page to a client machine;
receive, through the controller page, a service file package containing software components and a template file for a new service;
deploy the software components for the new service to one or more servers based on the template file;
update a database with information about the deployed new service; and
modify the service page to include the deployed new service.
